(19) United States
(12) Patent Application Publication
(10) Pub. No.: US 2017/0151753 A1
(43) Pub. Date: Jun. 1, 2017

(54) SANDWICH ELEMENT

(71) Applicant: DIEHL AIRCABIN GMBH, Laupheim (DE)

(72) Inventors: Andreas HARMS, Tannheim (DE); Matthias HOFFMANN, Mietingen (DE)

(21) Appl. No.: 15/361,570

(22) Filed: Nov. 28, 2016

(30) Foreign Application Priority Data
Nov. 26, 2015 (DE) 10 2015 015 340.4

(51) Int. Cl. B32B 7/02; B60R 13/02; B32B 5/02; B32B 9/02; B32B 7/12; B32B 5/18

(52) U.S. Cl. CPC B32B 7/02; B32B 7/12; B32B 5/18; B32B 5/02; B32B 9/025; B60R 13/02; B32B 2605/003; B32B 2255/02; B32B 2255/20; B32B 2307/3065; B32B 2307/536

(57) ABSTRACT

A sandwich element includes a base element and a structural element. The structural element forms a soft touch surface of the sandwich element, the structural element contains at least two functional layers, one of the functional layers is a soft touch layer and another of the functional layers is a decorative layer forming the soft touch surface. The soft touch layer is disposed between the decorative layer and the base element and a fire-retardant layer is disposed in the interior of the sandwich element.

### CROSS-REFERENCE TO RELATED APPLICATION

This application claims the priority, under 35 U.S.C. §119, of German Patent Application DE 10 2015 015 340.4, filed Nov. 26, 2015; the prior application is herewith incorporated by reference in its entirety.

### BACKGROUND OF THE INVENTION

### Field of the Invention

The invention relates to a sandwich element. The sandwich element contains a base element and a structural element and the structural element forms or provides a soft touch surface of the sandwich element.

Such sandwich elements with soft touch surfaces are often desired in the interior compartments of vehicles. In practice, for example in the case of passenger cabins as interior compartments of aircraft and vehicles, soft touch surfaces have only been used in VIP furnishings for special customers and not for series production. In some cases, those structures can be qualified with regard to fire resistance only by using a difficult process. Taking into account process and production fluctuations of the elements and materials used, there is a high risk that in cases where the structure, i.e. the sandwich element, is a delivery element, i.e. an individual sandwich element for final installation, it will not meet official standards. The reasons for not meeting official standards include the fact that PU or CR foams which are used are subject to major fluctuations in production, or the fact that in manual application of spray adhesives with a target application weight of 60 g/m² (grams per square meter), the actual application weight is in the range of 40 g/m² to 100 g/m². As an alternative to foams, spacer fabrics and webs can be used as functional layers. Moreover, it is not only spray adhesives which can or must be used. Thermoplastic adhesive films or PSA adhesive films can also be used. In some cases, when even minor changes in the decorative materials are made, for example changes in their color (different color pigments, dark/light), weight per unit area, or density, that requires complete redevelopment of the entire sandwich element.

A high-performance decorative laminate with a soft feel similar to that of leather or artificial leather for use in aviation is known from International Publication WO 2014/153108 A1, corresponding to U.S. Patent Application US 2014/153108. A poly(vinyl halide) or poly(vinylidene halide) film is coated with a flame-resistant multiblock copolymer, and that layer is optimized with regard to feel and flammability properties.

A sandwich element for a sound-absorbing interior liner for aircraft application is known from German Application DE 10 2010 033 271 A1. A fire-retardant layer containing metal particles can provide both improved fire protection and electromagnetic insulation.

### SUMMARY OF THE INVENTION

It is accordingly an object of the invention to provide a sandwich element, which overcomes the hereinafore-mentioned disadvantages of the heretofore-known devices of this general type and which provides soft touch surfaces in an improved manner.

With the foregoing and other objects in view there is provided, in accordance with the invention, a sandwich element (generally also referred to as a “furnishing element”) including a base element and a structural element. The structural element forms a soft touch surface of the sandwich element. In particular, the structural element provides a surface that has soft touch properties and is e.g. a visible side of the sandwich element or is accessible to touch. The soft touch property is generally provided by the structural element, with the base element not contributing to this soft touch property.

The structural element contains at least two functional layers, wherein in particular at least two of the functional layers are bonded to one another using an adhesive. In particular, the adhesive is an adhesive layer. In this case, the structural element is also a sandwich element or structure, so that different properties of the structural element can be controlled separately from one another by using different functional layers. In this manner, various particularly flexible structural elements can be produced with soft touch properties.

One of the functional layers is a soft touch layer, and another of the functional layers is a decorative layer. The soft touch layer is disposed between the decorative layer and the base element. The decorative layer forms the soft touch surface of the sandwich element, with the surface in particular being a visual side, i.e. a visual side surface. This combination makes it possible to configure soft touch properties with particular freedom.

The soft touch layer is an elastically deformable layer. It has a so-called memory effect, which means that it can be pushed in, and after being touched, returns to its original form. In particular, it is composed of materials such as fabric, foam, spacer fabrics, or webs. The layer thickness is 2 mm to 5 mm, and preferably 3 mm.

The haptic touch effect (soft touch) is controlled by the soft touch layer. The decorative layer, in contrast, is responsible for the haptic surface feel and the optical appearance of the structural element or sandwich element, and is composed, for example, of leather, artificial leather, fabric, or film. The decorative layer has a thickness of 0.5 mm to 2 mm, and preferably 1 mm. Both functions, i.e. the haptic touch effect and the haptic surface feel, can therefore be configured or varied separately from each other by using the individual layers in order to meet customer requirements to the most favorable extent possible.

The sandwich element has a flame-retardant layer in its interior. The flame-retardant layer is thus not a surface layer that, for example, would be accessible to direct touch. The surface layer is provided by the surface of the structural element.

The invention is based on the fundamental concept of developing an element with a soft touch surface that meets a wide variety of customer requirements and all official standards for fire behavior in vehicles, primarily in aircraft. In this case, a decorative material should be applicable in a serial process. The decorative material is the component providing an artistic effect on the surface or visible side of the element. With respect to structural modifications, simultaneous modifications in the basic structure of the sandwich element should be avoided, at least to the extent possible. The decorative layer is located in the structural element.

The invention is further based on the fundamental concept of providing a flame-retardant layer on the sandwich element in order to achieve a flame-retardant effect in the sandwich element in the case of fire. According to the invention, however, the flame-retardant layer is not configured on the surface or covering the surface, but is integrated into the sandwich element. In this case, the original properties of the soft touch surface are retained. The soft touch surface is the surface side of the structural element, facing away from the base element, and is located as a rule on the visible side or so as to be accessible to touch. The soft touch surface remains completely unchanged, and it can retain its original haptic and optical properties without being impaired by fire-retardant measures. Nevertheless, the desired flame-retardant effect is achieved for the entire sandwich element. The use of a flame-retardant layer, i.e. an additional flame inhibitor, makes it possible to carry out fireproof processing with various decorative materials such as leather, artificial leather, fabrics, and films, unlike in a conventional sandwich element with a base element and a structural element, composed for example of foams, spacer fabrics, etc. This is of particular importance in aviation. This allows unproblematic flammability qualification of soft touch surfaces or sandwich elements with soft touch surfaces. Various decorative materials such as artificial leather, fabrics, paints, etc. can be processed not only individually in VIP applications, but also in series production.

In some cases, the use of various materials that are critical for flame retardancy is only possible when flame-retardant layers are incorporated into the overall structure of sandwich elements. It is only by this method that it is possible to use such sandwich elements as interior fixtures of vehicles, particularly aircraft. Minor changes in decor can be carried out without having to completely modify or adapt the overall structure. This allows unproblematic flammability qualification of soft touch surfaces or the corresponding sandwich elements in aviation applications and the production of VIP interior fixtures in serial production. Depending on the criticality of the soft touch materials such as artificial leather, fabric, foam, spacer fabrics, etc., the flame-retardant layer is configured in such a way that the sandwich element meets required flammability values. As an alternative to foams, spacer fabrics and webs can also be used as functional layers.

According to the invention, the use of an additional flame-retardant layer in a sandwich element makes it possible to carry out fireproof processing of foams, spacer fabrics, etc. with various decorative materials such as leather, artificial leather, fabrics, etc. for aviation applications.

In a preferred embodiment, the flame-retardant layer is disposed between the base element and the structural element. This makes it possible to freely construct both the base element and the structural element in a conventional manner. The flame-retardant layer is simply interposed. This also makes it possible to prefabricate identical base elements with identical flame-retardant layers as identical carriers and to provide them with different structural elements.

In a preferred embodiment, the base element itself is a sandwich element or structure, in particular a fiber composite element. Alternatively, the base element is a monolithic or thermoplastic deep-drawn element. Since such base elements are used primarily in the field of aviation, the invention is particularly well-suited for use in this field. Not only sandwich elements (in particular pre-preg/honeycomb/pre-preg), but also monolithic (in particular multilayer pre-preg laminates) and thermoplastic deep-drawn elements, are optimized in their fire behavior by using a fire-retardant layer, in particular a coating forming an insulating layer.

In a preferred embodiment—provided that the fire-retardant layer is disposed between the base element and the structural element—the structural element is bonded by using an adhesive to the base element, which is already coated with the flame-retardant layer. In other words, the base element and the flame-retardant layer form a carrier as a combined element unit, to which the structural element is then bonded by using an adhesive. The fire behavior of the materials in the sandwich element is therefore significantly improved by coating as a pretreatment of the base element. In other words, the base element is first provided with a flame-retardant layer, and then decorated with a soft touch structure in the form of the structural element.

This variant also makes it possible, in particular, to produce modular systems in which identical carriers, i.e. base elements with a flame-retardant coating, can be provided with different structural elements.

In a preferred embodiment, the base element extends along an extension surface and has a flat side that also extends along the extension surface. The structural element and—in the aforementioned variant—the flame-retardant layer are then applied to the flat side. This results in sandwich elements with soft touch surfaces extending in planar fashion that can be used, in particular, for interior cladding in internal spaces of vehicles, for example as cabin panels and the like.

In a preferred embodiment, the flame-retardant layer is a coating layer. In other words, the flame-retardant layer can be coated onto the base element. The flame-retardant layer then corresponds to a protective coating. The coating layer provides flame-retardant pretreatment of the base element, with the coating layer being applied to the base element before the structural element is applied. In particular, the base element is coated in a planar fashion with a flame retardant as a flame-retardant layer and only then decorated with a soft touch structure in the form of the structural element.

In a preferred embodiment, the flame-retardant layer is an intumescent flame-retardant layer. In the case of fire, an intumescent layer expands to form a protective layer in order to protect the layers of the sandwich elements lying behind that layer in terms of the effect of the fire. For example, the layers to be protected can be the decorative layers of the structural element. In particular, the flame-retardant layer contains expandable graphite, which in the event of a fire forms a protective graphite layer. Alternatively or additionally, the flame-retardant layer is an ablative flame-retardant layer. In the case of fire, ablative systems also exert a protective fireproof effect by releasing water vapor and cooling the fire or diluting combustion gases. In particular, the flame-retardant layer contains aluminum hydroxide. Aluminum hydroxide forms an ablative flame-retardant layer. The two aforementioned materials have been established in practice to be effective as fire retardants.

In a preferred embodiment, the sandwich element is at least a section of an internal space structure of a vehicle. In particular, the internal space is a passenger cabin, and the vehicle is an aircraft. An internal space is e.g. a wall or ceiling element, a cladding, a cabin divider, a PSU (passenger supply unit), or the like. The sandwich elements are particularly well-suited for the aforementioned applications, since they can easily meet fire protection standards.

In particular, according to the invention, pretreatment or coating of an element in the form of the base element with a protective coating is carried out in order to optimize the fire behavior of decorative materials to be applied to that element. In particular, the coating is an ablative or intumescent layer, such as expandable graphite, which provides a protective function for the decor.

According to the invention, it is possible to individually configure the base element together with the flame-retardant layer individually for different structural elements. If necessary, these configurations can be very similar in cases where only minor variations in the flame-retardant layer are sufficient to meet the fire protection standards for a set of widely differing structural elements. However, the following is also possible:

An assortment of components includes at least two of the aforementioned sandwich elements according to the invention, in which the flame-retardant layer is disposed between the base element and the structural element. At least two of the sandwich elements show different paired structural elements. However, the respective base elements with the flame-retardant layer are implemented identically. It is therefore possible to quickly and simply apply different structural elements as needed to identical base elements with identical flame-retardant layers, which ideally are already available in prefabricated form, thus ensuring that all of the sandwich elements of the assortment of components produced meet the respective fire protection standards. For this purpose, for example, the flame-retardant layer is configured with a sufficiently strong flame-retardant effect to reliably protect critical structural elements of the assortment of components from fire. The other advantages of an assortment of components of this type have been explained above accordingly in connection with the sandwich element according to the invention.

The sandwich element and/or the assortment of components can be used at least as a section of an internal space structure of an internal space, in particular a passenger cabin, in the interior of a vehicle, particularly an aircraft. The critical standards for fire protection properties of sandwich elements, particularly in aviation, can be met by using the elements according to the invention. The other advantages of an application of this type have been explained above accordingly in connection with the sandwich element according to the invention.

In a production process, the base element is first provided with the flame-retardant layer, and the structural element is then applied to the base element, which has already been coated with the flame-retardant layer. The other advantages of a process of this type have been explained above accordingly in connection with the sandwich element according to the invention. This also applies to the following preferred embodiments.

In a preferred embodiment of the production process, the structural element is applied by using an adhesive to the base element. The adhesive is preferably an adhesive layer, and particularly preferably a spray adhesive. Moreover, it is not only spray adhesives which can or must be used. Thermoplastic adhesive films or PSA adhesive films can also be used. Production of such bonded sandwich elements can be carried out in a particularly simple and economical manner.

In a preferred embodiment of the production process, the flame-retardant layer is coated onto the base element as a coating layer. Processing of coatings with respect to sandwich elements can be carried out in a particularly simple manner.

Other features which are considered as characteristic for the invention are set forth in the appended claims.

Although the invention is illustrated and described herein as embodied in a sandwich element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, exploded, longitudinal-sectional view of a sandwich element according to the invention; and

FIG. 2 is a longitudinal-sectional view of an assortment or several components according to the invention.

### DETAILED DESCRIPTION OF THE INVENTION

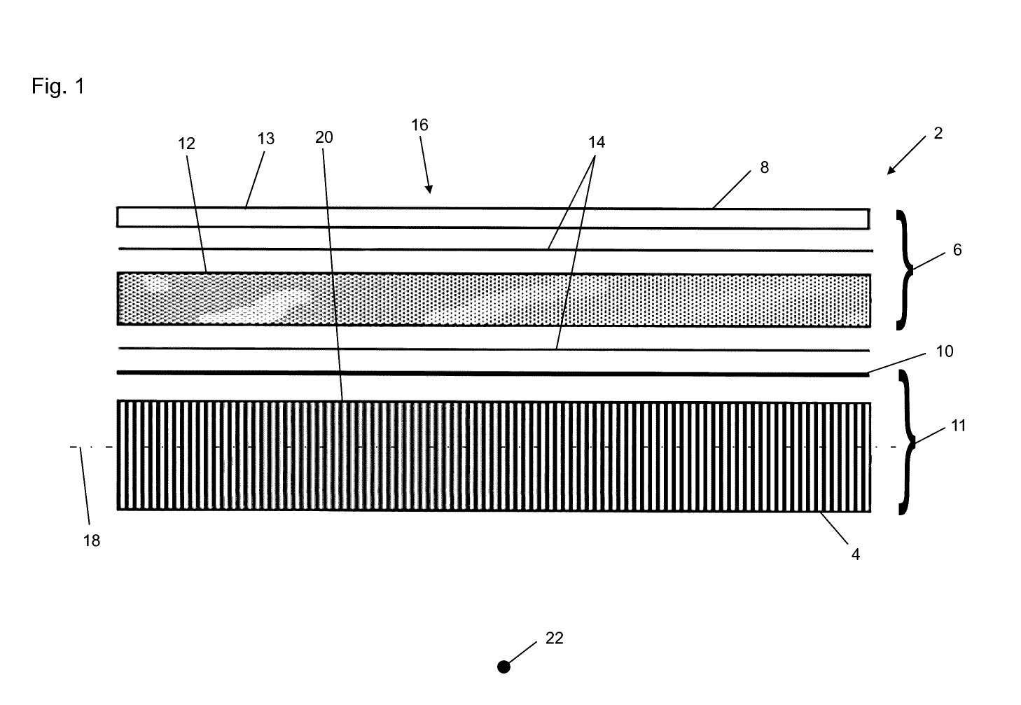

Referring now to the figures of the drawings in detail and first, particularly, to FIG. 1 thereof, there is seen a sandwich element 2 containing a base element 4 and a structural element 6. The structural element 6 forms or possesses a visible or touch-accessible soft touch surface 8 of the sandwich element 2. A flame-retardant layer 10 is disposed between the base element 4 and the structural element 6. The fire protection coating in the form of the layer 10 in this case is an intumescent fire protection coating based on expandable graphite. The base element 4 itself is a sandwich element or sandwich structure which is not shown in further detail, in this case a fiber composite element, which itself is composed of a plurality of layers which are not shown in further detail.

The structural element 6 contains two functional layers 12, 13 that are bonded to each other using an adhesive 14, in this case in the form of a flat adhesive layer. The adhesive 14 is a contact adhesive. The functional layer 12 is a soft touch layer. The functional layer 13 is a decorative layer. The functional layer 12 is disposed between the functional layer 13 and the base element 4. The functional layer 13, as a decorative layer, forms the surface, i.e. the soft touch surface 8 of the sandwich element 2. The soft touch surface 8 also constitutes a visible side 16 of the sandwich element 2. When installed in an internal space 22, in this case a passenger cabin of a vehicle which is not shown in further detail, in this case an aircraft, the visible side can be observed by passengers and/or is touch-accessible to passengers. The structural element 6 is also bonded by using the adhesive 14, in this case again an adhesive layer, to the base element 4 provided with the fire-retardant layer 10. The base element 4 and the fire-retardant layer 10 applied thereto together form a carrier 11 for the structural element 6.

FIG. 1 shows an exploded sectional view of the sandwich element 2. After completion of the sandwich element 2, all of the layers shown are actually bonded to one another in a strong and permanent fashion.

The base element 4 extends in a planar fashion along an extension surface 18, which in FIG. 1 runs transverse to the plane of the figure. The base element 4 therefore has a flat side 20 also extending parallel to the extension surface 18 or along that surface. Both the flame-retardant layer 10 and the structural element 6 (with the layer 10 being interposed) are applied to this flat side 20. In this example, the flame-retardant layer 10 is a coating layer that was coated onto the base element 4 before the structural element 6 was applied by using the adhesive 14 to the base element 4 coated with the flame-retardant layer 10.

The sandwich element 2 shown is a section of an internal space structure, in this case a side cladding, for example of an internal space 22 of a vehicle which is not shown in further detail, in this case an aircraft. The internal space 22 is the passenger cabin thereof.

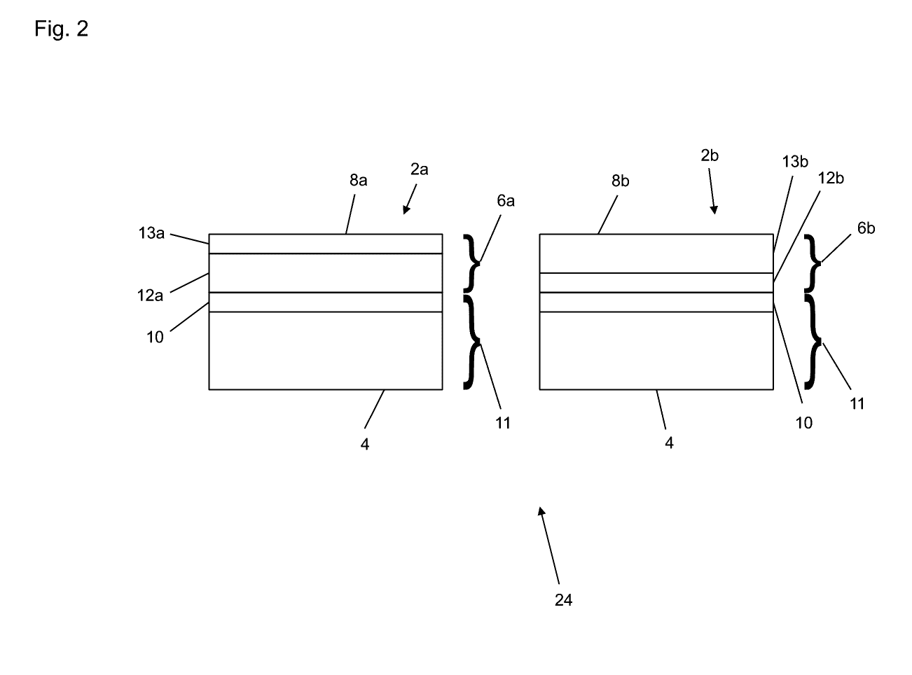

FIG. 2 shows an assortment or several components 24, in this case formed of two sandwich elements 2a, 2b that have different paired structural elements 6a, 6b. The base elements 4, together with the respective flame-retardant layers 10, i.e. the carriers 11, are configured identically. The structural elements 6a, 6b differ by having different functional layers 12a, 12b, which differ in this case in both their thickness and their material properties. The functional layer 12a is a soft touch layer in the form of a foam, and the functional layer 12b is a soft touch layer in the form of a spacing fabric.

The functional layers 13a, 13b differ in thickness, material properties, and color. The functional layer 13a is a decorative layer in the form of brown leather, and the functional layer 13b is a decorative layer in the form of red fabric. Different soft touch surfaces 8a, 8b having different appearances and haptic properties are thus produced.

1. A sandwich element, comprising:
an interior of the sandwich element;
a fire-retardant layer disposed in said interior;
a base element; and
a structural element;
said structural element forming a soft touch surface of the sandwich element;
said structural element containing at least two functional layers;
one of said functional layers being a soft touch layer and another of said functional layers being a decorative layer forming said soft touch surface; and
said soft touch layer being disposed between said decorative layer and said base element.

2. The sandwich element according to claim 1, wherein said fire-retardant layer is disposed between said base element and said structural element.

3. The sandwich element according to claim 1, wherein said base element is a sandwich structure.

4. The sandwich element according to claim 3, wherein said sandwich structure is a fiber composite element or a monolithic or thermoplastic deep-drawn element.

5. The sandwich element according to claim 1, which further comprises an adhesive or an adhesive layer bonding at least two of said functional layers to one another.

6. The sandwich element according to claim 1, wherein:
said base element is coated with said fire-retardant layer; and
an adhesive or an adhesive layer bonds said structural element onto said base element.

7. The sandwich element according to claim 1, wherein said base element extends in a planar manner along an extension surface, said base element has a flat side extending along said extension surface, and said structural element is applied to said flat side.

8. The sandwich element according to claim 1, wherein said base element extends in a planar manner along an extension surface, said base element has a flat side extending along said extension surface, and said fire-retardant layer is applied to said flat side.

9. The sandwich element according to claim 1, wherein said fire-retardant layer is a coating layer.

10. The sandwich element according to claim 1, wherein said fire-retardant layer is an intumescent fire-retardant layer.

11. The sandwich element according to claim 10, wherein said intumescent fire-retardant layer at least one of contains expandable graphite or is an ablative fire-retardant layer.

12. The sandwich element according to claim 11, wherein said ablative fire-retardant layer contains aluminum hydroxide.

13. The sandwich element according to claim 1, wherein the sandwich element is at least a section of an interior compartment structure of an interior compartment.

14. The sandwich element according to claim 1, wherein said interior compartment is disposed in a passenger cabin or in a vehicle or in an aircraft.
